(19) United States
(12) Patent Application Publication
(10) Pub. No.: US 2007/0172181 A1
(43) Pub. Date: Jul. 26, 2007

(54) Curable resin composition for optical waveguide, curable dry film for optical waveguide, optical waveguide and method for forming core part for optical waveguide

(75) Inventors: Genji Imai, Kanagawa (JP); Takahiro Higuchi, Kanagawa (JP)

Correspondence Address: FITCH, EVEN, TABIN & FLANNERY, P. O. BOX 18415, WASHINGTON, DC, 20036, US

(73) Assignee: Kansai Paint Co., Ltd., Hyogo (JP)

(21) Appl. No.: 10/590,737

(22) PCT Filed: Feb. 24, 2005
(86) PCT No.: PCT/JP05/03002

§ 371 Date: Aug. 25, 2006

(30) Foreign Application Priority Data
Feb. 25, 2004 (JP) 2004-049823

(51) Int. Cl. G02B 6/02; C08L 51/00; C08L 53/00; B32B 27/00

(52) U.S. Cl. 385/123; 525/70; 525/88; 428/500

(57) ABSTRACT

A curable resin composition for optical waveguide comprising, as essential components, a copolymer (A) of a radical-polymerizable compound (a) having an acid anhydrous group and/or an acidic group carrying a blocked acid group, and a radical-polymerizable unsaturated group in the molecule, with other radical-polymerizable compound (b), a polymerizable unsaturated compound (B), and a polymerization initiator (C); a curable dry film for optical waveguide composed of this composition; and an optical waveguide in which at least one of a lower clad layer 13, a core part 15 and a upper clad layer 17 is formed using the same.

### TECHNICAL FIELD

The present invention relates to a curable resin composition for optical waveguide, a curable dry film for optical waveguide, an optical waveguide and a method for forming a core part for an optical waveguide.

### BACKGROUND ART

Recently, for requirement of higher speed and larger capacity of information treatments in optical communication systems and computers, optical waveguides as light transmission media are paid to attention. As such optical waveguides, quartz-based waveguides are typical. However, for production of quartz-based waveguides, a special production apparatus is necessary and a longer production time is required.

On the other hand, a radiation-curable dry film for forming optical waveguide which can form an optical waveguide in a short period of time and at low cost only by laminating the film on a base material, irradiating the film with a given amount of optical, then, performing development, instead of quartz-based waveguides, and a method for producing an optical waveguide using the same, are suggested (see, Japanese Patent Application Laid-Open (JP-A) No. 2003-202437).

A resin composition for optical waveguide is known containing an ethylenically unsaturated group-containing carboxylic acid resin having at least one ethylenically unsaturated group and at least one carboxyl group in the molecule, a diluting agent, and a photo-polymerization initiator as a resin composition forming an optical waveguide (see, JP-A No. 2003-149475).

JP-A No. 2003-202437 describes a copolymer obtained from a radical-polymerizable compound having a carboxyl group, and other radical-polymerizable compound and having a softening temperature of 20 to 150° C., as an alkali-developable carboxyl group-containing resin component constituting a dry film. However, a dry film for forming optical waveguide using this carboxyl group-containing resin has a defect that, in coating of the composition on releasing paper of PET and the like to attain lamination, and in handling works such as winding of the laminated dry film, pasting of the laminated dry film on a base material to form an optical waveguide, the dry film generates failures such as cracking and splitting, lowering the performance of the optical waveguide.

JP-A No. 2003-149475 includes no description of use as a dry film of the resin composition for optical waveguide. Even if this resin composition is used as a dry film, there is a defect that, in coating of the composition on releasing paper of PET and the like to attain lamination, and in handling works such as winding of the laminated dry film, pasting of the laminated dry film on a base material to form an optical waveguide, the dry film generates failures such as cracking and splitting, lowering the performance of the optical waveguide, like the dry film described in JP-A No. 2003-202437. Also when the resin composition for optical waveguide described in JP-A No. 2003-149475 is used in the form of solution, the finally obtainable optical waveguide does not have sufficient mechanical properties such as processability and bending, therefore, failures such as cracking and splitting are generated in fitting an optical waveguide at a necessary position or processing an optical waveguide, giving a defect of lowering the performance of the optical waveguide.

Further, those described in both the publications generate a problem of corrosion of a stainless storage vessel and the like by a carboxyl group, and manifest no sufficient performances such as the storage stability of a dry film, and the like.

### DISCLOSURE OF THE INVENTION

The present invention has an object of providing an optical waveguide having excellent performances without lowering particularly stability, coated film processability and mechanical nature, and providing a curable resin composition for optical waveguide, a curable dry film for optical waveguide and a method for forming a core part for optical waveguide, useful for forming such an excellent optical waveguide.

The present invention relates to a curable resin composition for optical waveguide comprising, as essential components,
a copolymer (A) of a radical-polymerizable compound (a) having an acid anhydrous group and/or an acidic group carrying a blocked acid group, and a radical-polymerizable unsaturated group in the molecule, with other radical-polymerizable compound (b),
a polymerizable unsaturated compound (B), and
a polymerization initiator (C).

Further, the present invention relates to a curable dry film for optical waveguide comprising, as essential components,
a copolymer (A) of a radical-polymerizable compound (a) having an acid anhydrous group and/or an acidic group carrying a blocked acid group, and a radical-polymerizable unsaturated group in the molecule, with other radical-polymerizable compound (b), the copolymer having a softening temperature of 0 to 300° C.,
a polymerizable unsaturated compound (B), and
a polymerization initiator (C).

Furthermore, the present invention relates to an optical waveguide comprising a lower clad layer, a core part and an upper clad layer wherein at least one of the lower clad layer, the core part and the upper clad layer is formed of a cured substance of a curable dry film for optical waveguide comprising, as essential components,
a copolymer (A) of a radical-polymerizable compound (a) having an acid anhydrous group and/or an acidic group carrying a blocked acid group, and a radical-polymerizable unsaturated group in the molecule, with other radical-polymerizable compound (b), the copolymer having a softening temperature of 0 to 300° C.,
a polymerizable unsaturated compound (B), and
a polymerization initiator (C).

Still further, the present invention relates to a method for forming a core part for optical waveguide, comprising the following steps:
(1) a step of coating or pasting the curable resin composition for optical waveguide according to claim 1 or the curable dry film for optical waveguide according to claim 4 on a base material for optical waveguide, to provide a resin layer for optical waveguide to be a core part of an optical waveguide,
(2) a step of irradiating light to cure a part to be a core part,
(3) a step of dissociating a blocking agent in an un-cured layer to generate an acidic group, and
(4) a step of removing the un-cured layer by a development treatment to form a core part (the step (3) may be carried out simultaneously).

### BRIEF EXPLANATION OF DRAWINGS

FIG. 1 is a sectional view viewed from the side (thickness) direction and the upper direction of an optical waveguide according to the present invention.

FIG. 2 is a sectional view viewed from the front direction of the cut surface in FIG. 1.

FIG. 3 is a view showing a method for producing an optical waveguide according to the present invention.

### BEST MODES FOR CARRYING OUT THE INVENTION

The curable resin composition for optical waveguide of the present invention comprises, as essential components, a copolymer (A) of a radical-polymerizable compound (a) having an acid anhydrous group and/or an acidic group carrying a blocked acid group, and a radical-polymerizable unsaturated group in the molecule, with other radical-polymerizable compound (b), a polymerizable unsaturated compound (B), and a polymerization initiator (C). In the following descriptions, the radical-polymerizable compound (a) having an acid anhydrous group and a radical-polymerizable unsaturated group in the molecule is abbreviated as “compound (a1)”, and the radical-polymerizable compound (a) having an acidic group carrying a blocked acid group and a radical-polymerizable unsaturated group in the molecule is abbreviated as “compound (a2)”, in some cases.

Copolymer (A):

The copolymer (A) is a radical copolymer of a radical-polymerizable compound [compound (a1)] having an acid anhydrous group and a radical-polymerizable unsaturated group in the molecule or a radical-polymerizable compound [compound (a2)] having an acidic group carrying a blocked acid group and a radical-polymerizable unsaturated group in the molecule, with (b) other radical-polymerizable compound.

The copolymer (A) includes also copolymers obtained by producing an acidic group-containing copolymer of a radical polymerizable compound having an un-blocked acidic group and a radical polymerizable unsaturated group in the molecule, with other radical polymerizable compound, then, blocking an acid group of the copolymer with a blocking agent.

Compound (a1):

The compound (a1) is a radical polymerizable compound containing an acid anhydrous group and a radical polymerizable unsaturated group in the molecule. Specific examples thereof include maleic anhydride.

Compound (a2):

The compound (a2) is a radical polymerizable compound containing an acidic group carrying a blocked acid group, and a radical polymerizable unsaturated group in the molecule. The acid group to be blocked is preferably at least one group selected from a carboxyl group, phosphoric acid group, sulfonic acid group and phenolic hydroxyl group. The blocking agent for blocking an acid group is preferably at least one group selected from a tert-butyl group, tert-BOC group (tert-butoxycarbonyl group) and ether-bonded olefinic unsaturated group.

For example, a dry film is pasted on a base material and the like, then, the blocking is released by dissociation of a blocking agent by a heating treatment or by dissociation of a blocking agent by a hydrolysis reaction by treatment with a developer, to reproduce an acidic group. Since this acidic group after releasing of a blocking agent is bonded to a copolymer (A), a dry film at an un-cured part (un-irradiated part) shows desired alkali solubility. As a result, a dry film at an un-cured part (un-irradiated part) is dissolved by an alkali developer and the like, thus, an optical waveguide (core part or the like) can be formed successfully.

It is also possible that, by simultaneous use of an photacid generator, an acid generated by the photacid generator dissociates blocking, a copolymer (A) is allowed to reproduce an acidic group, a dry film at an irradiated part is dissolved and removed by an alkali developer, thus, an optical waveguide (core part or the like) can be formed successfully.

The compound (a2) can be obtained by blocking an acid group of a radical polymerizable compound containing an acidic group and a radical polymerizable unsaturated group in the molecule. Specific examples of the radical polymerizable compound containing an acidic group and a radical polymerizable unsaturated group in the molecule include radical polymerizable compounds containing a carboxyl group such as acrylic acid and methacrylic acid; radical polymerizable compounds containing phosphoric acid such as acryloyloxyethyl phosphate, methacryloyloxyethyl phosphate and mono(2-hydroxyethyl acrylate)acid phosphate; and radical polymerizable compounds containing a sulfonic acid group such as sulfopropyl acrylate and sulfopropyl methacrylate.

As the blocking agent to be used for obtaining a compound (a2), there are mentioned, for example, blocking agents containing a tert-butyl group or tert-BOC group such as poly(tert-butoxycarbonyloxystyrene), poly(tert-butoxycarbonyloxy-α-styrene) and poly(tert-butoxystyrene); and blocking agents containing an ether-bonded olefinic unsaturated group such as a vinyl ether group [formula: —R—O—CH═CH₂ (wherein, R represents a straight or branched alkylene group having 1 to 6 carbon atoms such as ethylene, propylene and butylene)], 1-propenyl ether group and 1-butenyl ether group.

Specific examples of the blocking agent include aliphatic vinyl ether compounds such as methyl vinyl ether, ethyl vinyl ether, isopropyl vinyl ether, n-propyl vinyl ether, n-butyl vinyl ether, isobutyl vinyl ether, 2-ethylhexyl vinyl ether and cyclohexyl vinyl ether, and corresponding aliphatic vinyl thioether compounds; cyclic vinyl ether compounds such as 2,3-dihydrofuran, 3,4-dihydrofuran, 2,3-dihydro-2H-pyran, 3,4-dihydro-2H-pyran, 3,4-dihydro-2-methoxy-2H-pyran, 3,4-dihydro-4,4-dimethyl-2H-pyran-2-one and 3,4-dihydro-2-ethoxy-2H-pyran, and corresponding cyclic vinyl thioether compounds.

Radical Polymerizable Compounds (b):

The compound (b) is not particularly restricted providing it has radical copolymerization reactivity with a compound (a), and conventionally known various radical polymerizable compounds can be used. This compound (b) can be used, for example, to control the softening temperature of a copolymer (A) used in a dry film in a range of 0 to 300° C. The amount of styrene in a copolymer (A) used in a core part can also be set larger than the amount of styrene in a copolymer (A) used in a clad layer, to control the difference in specific refractive index between the refractive index of a clad layer and the refractive index of a core part [=(core refractive index−clad refractive index)/core refractive index] at 0.1% or more.

Examples of the compound (b) include alkyl or cycloalkyl ester monomers of (meth)acrylic acid such as methyl (meth)acrylate, ethyl (meth)acrylate, propyl (meth)acrylate, n-butyl (meth)acrylate, isobutyl (meth)acrylate, tert-butyl (meth)acrylate, 2-ethylhexyl (meth)acrylate, cyclohexyl (meth)acrylate, n-octyl (meth)acrylate, lauryl (meth)acrylate, dodecyl (meth)acrylate, stearyl (meth)acrylate, 2-ethylhexyl carbitol (meth)acrylate and isobornyl (meth)acrylate; alkoxy alkyl ester monomers of (meth)acrylic acid such as methoxybutyl (meth)acrylate, methoxyethyl (meth)acrylate, ethoxybutyl (meth)acrylate and trimethylolpropane tripropoxy (meth)acrylate; aromatic vinyl monomers such as styrene, α-methylstyrene and vinyltoluene; α,β-ethylenically unsaturated carboxylic acid monomers such as (meth)acrylic acid and maleic acid; acrylphosphate monomers such as dimethylphosphate ethyl acrylate and diethylphosphate ethyl acrylate; epoxy group-containing unsaturated monomers such as glycidyl (meth)acrylate, 3,4-epoxycyclohexyl methyl(meth)acrylate and glycidyl ether; hydroxyl group-containing unsaturated monomers such as 2-hydroxy ethyl (meth)acrylate, 2-hydroxy propyl (meth)acrylate, 2-hydroxy-3-phenoxy propyl (meth)acrylate, 3-hydroxy propyl (meth)acrylate, hydroxyl butyl (meth)acrylate, (poly)alkylene glycol monoacrylate, and adducts of these monomers with lactones (for example, e-caprolactone and the like); esters of aromatic alcohols with (meth)acrylic acid such as benzyl (meth)acrylate; adducts of glycidyl (meth)acrylate or hydroxyalkyl ester of (meth)acrylic acid with monocarboxylic acid compounds such as capric acid, lauric acid, lonolic acid, oleic and the like, adducts of (meth)acrylic acid with monoepoxy compounds such as “Cardula E10” (trade name, manufactured by Shell Chemical); chain alkyl vinyl ethers such as ethyl vinyl ether, propyl vinyl ether, butyl vinyl ether, hexyl vinyl ether and octyl vinyl ether; cycloalkyl vinyl ethers such as cyclopentyl vinyl ether and cyclohexyl vinyl ether; allyl ethers such as allyl glycidyl ether and allyl ethyl ether; fluorine-containing unsaturated monomers such as perfluorobutyl ethyl (meth)acrylate, perfluoroisononyl ethyl (meth)acrylate and perfluorooctyl ethyl (meth)acrylate; nitrogen-containing unsaturated monomers such as (meth)acryloylmorpholine, 2-vinylpyridine, 1-vinyl-2-pyrrolidone, vinylcaprolactam, dimethyl(meth)acrylamide, N,N-dimethyl ethyl (meth)acrylate and diacetoneacrylamide. The above-mentioned unsaturated compounds may be used singly or in combination of two or more.

The radical copolymerization reaction of a compound (a) with a compound (b) can be carried out by the same method as a method for producing a copolymer by a general copolymerization reaction.

Regarding the compounding ratio of a compound (a) with a compound (b), the ratio of compound (a)/compound (b) is preferably in a range of 5 to 99%/95 to 1%, particularly, more preferably in a range of 10 to 90%/90 to 10% when the total weight of both the compounds (a) and (b) is 100%.

The number-average molecular weight of a copolymer (A) is preferably in a range of about 1000 to 200000, more preferably in a range of about 2000 to 80000. When the number-average molecular weight is 1000 or more, processability of a dry film tends to be excellent. In general, a dry film is heated and pasted on a base material, and when the number-average molecular weight is 200000 or less, there is a tendency that viscosity lowers moderately by this heating, pasting workability becomes excellent, and problems such as generation of foams after pasting hardly occur.

In the copolymer (A), the content of an acid anhydrous group and an acidic group having a blocked acid group in one molecule is preferably 0.5 to 50 on average, particularly, more preferably 1 to 10 on average. When this content is 0.5 or more on average, there is a tendency that developability by an alkali developer is improved and an optical waveguide of excellent performance is obtained. When this content is 50 or less on average, there is a tendency that developability by an alkali developer doesn't become too high and a sharp optical waveguide can be formed.

The softening temperature of a copolymer (A) is preferably in a range of 0 to 300° C., particularly, more preferably in a range of 10 to 250° C. In general, a dry film is heated and pasted on a base material, and when the softening temperature is 0° C. or more, there is a tendency that stickiness rarely lowers even by this heating, pasting workability becomes excellent, and problems such as generation of foams after pasting hardly occur. When the softening temperature is 300° C. or less, there is a tendency that pasting workability of a dry film is excellent, and problems such as degeneration and deformation of a base material to which a dry film is pasted hardly occur. Here, the softening temperature (TMA) is measured by thermal deformation phenomenon of a sheet having a thickness of 1 mm using Thermomechanical Analyser manufactured by DuPont. Namely, a quartz needle is placed on a sheet, a load of 49 g is applied, temperature is raised at a rate of 5° C./minute, and temperature when the needle penetrates by 0.635 mm is measured as the softening temperature (TMA).

Polymerizable Unsaturated Compound (B):

As the compound (B), various compounds mentioned previously as specific examples of the radical polymerizable compound (b) can be used. Further, as additional compounds, there can be used, for example, polyhydric alcohol modified poly-functional monomers such as ethylene glycol di(meth)acrylate, diethylene glycol di(meth)acrylate, triethylene glycol di(meth)acrylate, tetra- or more poly(4 to 16)ethylene glycol di(meth)acrylate, propylene glycol di(meth)acrylate, trimethylolpropane tri(meth)acrylate, pentaerythritol tetra(metha)acrylate, ethylene glycol diitaconate and ethylene glycol dimaleate; other poly-functional polymerizable unsaturated compounds such as hydroquinone di(meth)acrylate, resorcinol di(meth)acrylate and pyrogallol (meth)acrylate. The compound (B) may be used singly or in combination of two or more.

Initiator (C):

As the initiator (C), conventionally known initiators can be used. Specific examples thereof include aromatic carbonyl compounds such as benzophenone, benzoin methyl ether, benzoin isopropyl ether, benzylxanthone, thioxanthone and anthraquinone; acetophenones such as acetophenone, propiophenone, α-hydroxyisobutylphenone, α,α′-dichloro-4-phenoxyacetophenone, 1-hydroxy-1-cyclohexylacetophenone and diacetylacetophenone; organic peroxides such as benzoyl peroxide, t-butyl peroxy-2-ethyl hexanoate, t-butyl hydroperoxide, di-t-butyl diperoxy isophthalate and 3,3′,4,4′-tetra(t-butyl peroxycarbonyl)benzophenone; diphenylhalonium salts such as diphenyliodo bromide and diphenyliodonium chloride; organic halides such as carbon tetrabromide, chloroform and iodoform; heterocyclic and polycyclic compounds such as 3-phenyl-5-isooxazolone and 2,4,6-tris(trichloromethyl)-1,3,5-triazinebenzanthrone; azo compounds such as 2,2′-azo(2,4-dimethylvaleronitrile), 2,2-azobisisobutyronitrile, 1,1′-azobis(cyclohexane-1-carbonitrile) and 2,2′-azobis(2-methylbutyronitrile); iron-allene complex (see, EP No. 152377); titanocene compound (see, JP-A No. 63-221110), bisimidazole-based compound; N-aryglycidyl-based compound; acridine-based compound; aromatic ketone/aromatic amine combination; peroxyketal (see, JP-A No. 6-321895), and the like. Among the above-mentioned photo-radical polymerization initiators, di-t-butyl diperoxy isophthalate, 3,3′,4,4′-tetra(t-butyl peroxy carbonyl)benzophenone, iron-allene complex and titanocene compound manifest high activity for cross-linking or polymerization, thus, these compounds are preferably used.

Examples of trade names include Irgacure 907 (manufactured by Chiba Specialty Chemicals), Irgacure 651 (manufactured by Chiba Specialty Chemicals, acetophenone-based photo-radical polymerization initiator), Irgacure 184 (manufactured by Chiba Specialty Chemicals, acetophenone-based photo-radical polymerization initiator), Irgacure 1850 (manufactured by Chiba Specialty Chemicals, acetophenone-based photo-radical polymerization initiator), Irgacure 369 (manufactured by Chiba Specialty Chemicals, aminoalkylphenone-based photo-radical polymerization initiator), Lucirin TPO (manufactured by BASF, 2,4,6-trimethylbenzoyl diphenylphosphine oxide), Kayacure DETXS (manufactured by Nippon Kayaku Co., Ltd.) CGI-784 (manufactured by Chiba Geigy, titanium complex compound), UVI-6950, UVI-6970, UVI-6974 and UVI-6990 (these are manufactured by Union Carbide), Adeka Optomer SP-150, SP-151, SP-170 and SP-171 (these are manufactured by Asahi Denka Kogyo K.K.), Irgacure 261 (manufactured by Chiba Specialty Chemicals), CI-2481, CI-2624, CI-2639 and CI-2064 (these are manufactured by Nippon Soda Co., Ltd.), CD-1010, CD-1011 and CD-1012 (these are manufactured by Sartomer), DTS-102, DTS-103, NAT-103, NDS-103, TPS-102, TPS-103, MDS-103, MPI-103, BBI-101, BBI-102 and BBI-103 (these are manufactured by Midori Kagaku Co., Ltd.), Degacure K126 (manufactured by Degussa), and the like. These initiators (C) may be used singly or in combination of two or more.

Regarding the content (in terms of solid component) of each component of the curable resin composition for optical waveguide of the present invention, the content of a compound (B) is preferably 20 to 200 parts by weight, more preferably 30 to 100 parts by weight and the content of an initiator (C) is preferably 0.1 to 20 parts by weight, more preferably 1 to 10 parts by weight, based on 100 parts by weight of a copolymer (A). When the content of a compound (B) is in the above-mentioned range, there is a tendency that processability and mechanical stability are excellent. When the content of an initiator (C) is 0.1 part by weigh or more, there is a tendency that hardability is excellent and When the content is 20 parts by weight or less, there is a tendency that storability is excellent.

In the curable resin composition for optical waveguide of the present invention, a polyepoxide can be compounded, if necessary. Specific examples of the polyepoxide include bisphenol type epoxy resins obtained by a reaction of bisphenols with a haloepoxide such as epichlorohydrin and β-methylepichlorohydrin, halogenated bisphenol type epoxy resins, phosphorus-modified bisphenol type epoxy resins obtained by a chemical reaction of phosphorus compounds; alicyclic epoxy resins obtained by a hydrogenation of the above bisphenol type epoxy resins; novolak type epoxy resins obtained by reacting a haloepoxide to phenol novolak resins and cresol novolak resins; glycidyl ester type epoxy resins obtained by reacting poly-basic acids such as phthalic acid and dimeric acid, and epichlorohydrin; glycidylamine type epoxy resins obtained by reacting polyamines such as diaminodiphenylmethane and isocyanuric acid with epichlorohydrin; linear aliphatic epoxy resins and alicyclic epoxy resins obtained by oxidizing an olefin bond with a peracid such as peracetic acid; biphenyl type epoxy resins obtained by reacting biphenols with epichlorohydrin; and the like. Of them, bisphenol type epoxy resins, novolak type epoxy resins and the like manifesting significant effect in improving heat resistance necessary for an optical waveguide are preferably compounded. In the curable resin composition for optical waveguide of the present invention, an acidic group is blocked, thus, even if such a polyepoxide is compounded, there is utterly no fear of thickening and molecular weight increasing leading to impossibility of coating.

In the curable resin composition for optical waveguide of the present invention, an additive, reaction promoter, photo-acid generator, photosensitizer and the like can be compounded, if necessary.

The curable resin composition for optical waveguide of the present invention can be used as an organic solvent-based resin composition by dissolving or dispersing the above-mentioned compound (A), compound (B) and initiator (C) in an organic solvent. The organic solvent includes conventionally known organic solvents, for example, ketones, esters, ethers, cellosolves, aromatic hydrocarbons, alcohols and halogenated hydrocarbons. Further, the curable resin composition for optical waveguide of the present invention can be used as an aqueous resin composition by dispersing the above-mentioned components in water with a surfactant and the like.

The curable dry film for optical waveguide of the present invention is a dry film containing the same essential components as in the curable resin composition for optical waveguide of the present invention. Thought the method for producing a dry film is not particularly restricted, for example, the above-mentioned organic solvent-based resin composition or aqueous resin composition is coated and printed on a supporting base material to form wet film, then, dried at temperatures not causing curing by polymerization, thus, a dry film can be formed. The dry film formed on the supporting base material is peeled, and this single dry film can be used as a material for optical waveguide. It is also possible that, without peeling from the supporting base material, the dry film can be used as a material for optical waveguide, before peeling the unnecessary supporting base material.

As the supporting base material, for example, any of films of polyethylene terephthalate, aramide, capton, polymethylpentene, polyethylene and polypropylene can be used, and particularly, use of a polyethylene terephthalate film is judged to be optimum from the standpoint of cost and obtaining an excellent property as a photosensitive dry film. The thickness of the supporting base material is usually in a range of 1 μm to 2 mm, particularly, preferably 1 μm to 1 mm.

As the method for coating or printing the above-mentioned resin composition on these supporting base materials, for example, a roller method, spray method and silk screen method can be used. The thickness of a dry film may be appropriately selected depending on the optical waveguide to be produced, and usually in a range of 1 μm to 10 mm, particularly, preferably 5 μm to 5 mm.

The optical waveguide of the present invention has a lower clad layer, a core part and an upper clad layer wherein at least one of these lower clad layer, core part and upper clad layer is formed of a cured substance of a curable dry film for optical waveguide of the present invention.

The method for forming a core part for optical waveguide of the present invention comprises the following processes:

(1) a step of coating or pasting a curable resin composition for optical waveguide according of the present invention or a curable dry film for optical waveguide according to the present invention on a base material for optical waveguide, to provide a resin layer for optical waveguide to be a core part of an optical waveguide,

(2) a step of irradiating light to cure a part to be a core part,

(3) a step of dissociating a blocking agent in an un-cured layer to generate an acidic group, and

(4) a step of removing the un-cured layer by a development treatment to form a core part (the above-mentioned process (3) may be carried out simultaneously).

One embodiment of an optical waveguide using the dry film of the present invention and one embodiment of the method for producing an optical waveguide of the present invention will be illustrated specifically below, referring appropriately to drawings.

(Basic Constitution of Optical Waveguide)

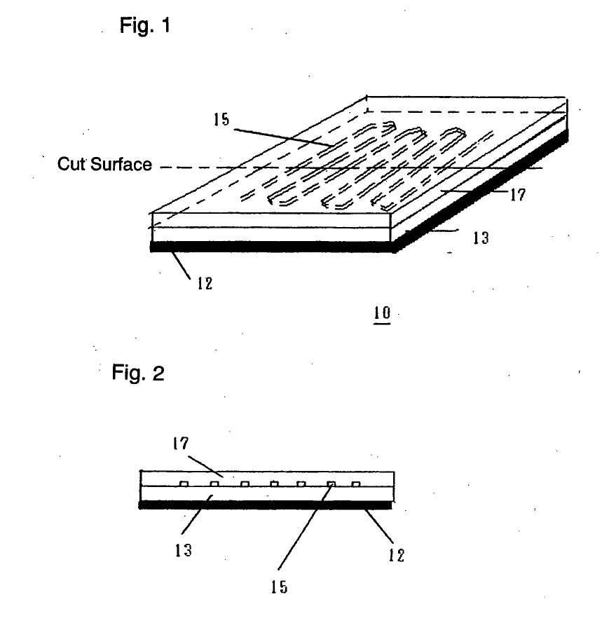

FIG. 1 is a sectional view showing a basic constitution of an optical waveguide constituted by applying a curable dry film for forming optical waveguide. As shown in this FIG. 1, an optical waveguide 10 is constituted of a base plate 12, a lower clad layer 13 formed on the surface of this base plate 12, a core part 15 having specific width formed on this lower clad layer 13, and an upper clad layer 17 laminated on the lower clad layer 13 containing this core part 15. The core part 15 is coated, including its side part, by the lower clad layer 13 and the upper clad layer 17, giving totally buried condition, so that waveguide low is small.

(Thickness and Width)

Though the thicknesses of the lower clad layer 13, upper clad layer 17 and core part (core layer) 15 are not particularly restricted in the optical waveguide having the constitution as described above, it is preferable, for example, that the thickness of the lower clad layer 13 is 1 to 200 μm, the thickness of the core part 15 is 1 to 200 μm and the thickness of the upper clad layer 17 is 1 to 200 μm. Also, though the width of the core part 15 is not particularly restricted, it is preferable, for example, that the width is in a range of 1 to 200 μm.

(Refractive Index)

It is necessary that the refractive index of the core part 15 is equal to or larger than both the refractive index of the lower clad layer 13 and the refractive index of the upper clad layer 17. Therefore, it is preferable that the refractive index of the core part 15 is in a range of 1.420 to 1.650 and the refractive indices of the lower clad layer 13 and the upper clad layer 17 are in a range of 1.400 to 1.648, respectively, for light having a wavelength of 400 to 1600 nm. It is preferable that the difference in specific refractive index between the core part and the clad layer is 0.1% or more, and particularly, it is preferable that the refractive index of the core part is larger than the refractive index of the clad layer by at least 0.1%. Here, an interference filter of 850 nm is set on a multi-wavelength Abbe refractometer DR-M4 manufactured by ATAGO, the refractive indexes of film samples are measured at 23° C., and the difference in specific refractive index is calculated according to the formula: [(refractive index of core part−refractive index of clad part)/refractive index of core part].

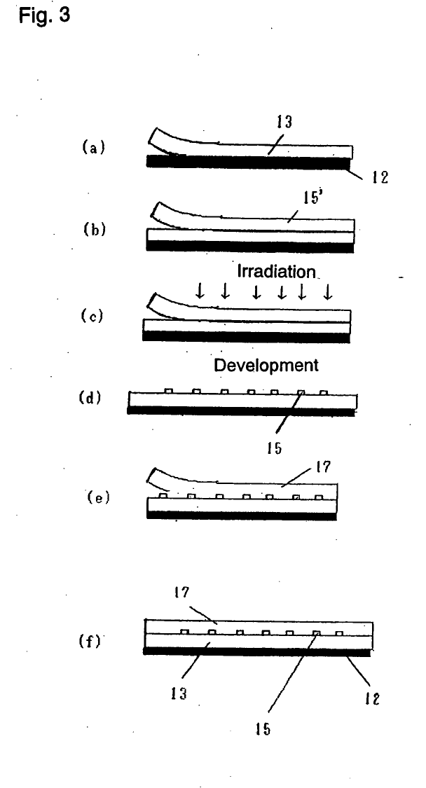

FIG. 2 is a sectional view viewed from the front direction of the cut surface in FIG. 1. An optical waveguide 10 is formed via a process as shown in FIG. 3. Namely, it is preferable that curable dry films for forming optical waveguide for forming any of the lower clad layer 13, core part 15 and upper clad layer 17 or all of the layers are sequentially transferred onto a base material, then, the optical waveguide 10 is formed by curing the films by a beam. In the following formation example, a curable dry film for forming optical waveguide of the present invention is used for forming, particularly, the core part 15.

(Preparation of Base Plate)

First, a base plate 12 having a flat surface is prepared. Though the kind of this base plate 12 is not particularly restricted, for example, a silicon base plate and glass base plate can be used.

(Process for Forming Lower Clad Layer)

This is a process in which the lower clad layer 13 is formed on the surface of the prepared base plate 12. Specifically, as shown in FIG. 3(a), a dry film is transferred onto the surface of the base plate 12 by applying suitable heat and pressure using a pressure bonding means such as a normal pressure heat roll pressure bonding method, vacuum heat roll pressure bonding method and vacuum heat press pressure bonding method while removing a cover film so that a base film faces upper direction. By irradiating this membrane for lower layer with a beam to cure the membrane, the lower clad layer 13 can be formed. In the process for forming the lower clad layer 13, it is preferable that the whole surface of the membrane is irradiated with a beam to cure the whole body.

Though the dose of a beam in forming the lower clad layer 13 is not particularly restricted, it is preferable to irradiate a beam having a wavelength of 200 nm to 390 nm and an illuminance of 1 to 500 mW/cm² so that the dose is 10 to 5000 mJ/cm², performing exposure. As the kind of the beam to be irradiated, visible ray, ultraviolet ray, infrared ray, x-ray, χ, α-ray, β-ray and γ-ray can be used, and particularly, ultraviolet ray is preferable. As the beam irradiation apparatus, for example, a high pressure mercury lamp, low pressure mercury lamp, metal halide lamp and excimer lamp are preferably used.

Next, a curable dry film for forming optical waveguide for forming a core part is transferred onto the surface of the lower clad layer 13 by applying suitable heat and pressure using a pressure bonding means such as a normal pressure heat roll pressure bonding method, vacuum heat roll pressure bonding method and vacuum heat press pressure bonding method while removing a cover film so that a base film faces upper direction [FIG. 3(b)] in the same manner as for forming the lower clad layer 13. This layer 15′ for forming core part is irradiated with a beam so that a core part is formed, causing curing [FIG. 3(c)]. Then, an un-cured part is removed by a developer, to form a core part 15 on the surface of the lower clad layer 13 [FIG. 3(d)].

After formation of the core part 15, a dry film for forming upper clad layer 17 is transferred onto the core part 15 and lower clad layer 13 as shown in FIG. 3(e) in the same manner as in the above-mentioned method [FIG. 3(e)]. Thereafter, irradiation with a beam can be performed from the front surface of the surface of the upper clad layer 17, to produce an optical waveguide of the present invention [FIG. 3(f)].

As the developer, organic solvents or, alkali aqueous solutions composed of alkalis such as sodium hydroxide, potassium hydroxide, sodium carbonate hydroxide, sodium silicate, sodium metasilicate, ammonia, ethylamine, n-propylamine, diethylamine, di-n-propylamine, triethylamine, methyldiethylamine, N-methylpyrrolidone, dimethylethanolamine, triethanolamine, tetramethylammonium hydroxide, tetraethylammonium hydroxide, choline, pyrrole, piperidine, 1,8-diazabicyclo[5.4.0]-7-undecene and 1,5-diazabicyclo[4.3.0]-5-nonane can be used. When an alkali aqueous solution is used, it is preferable that its concentration is usually in a range of 0.05 to 25 wt %, preferably 0.1 to 3.0 wt %. It is also preferable that a water-soluble organic solvent such as methanol and ethanol, and a surfactant and the like are added in suitable amounts to such an alkali aqueous solution, and the resulting solution is used as the developer.

The development time is usually 30 to 600 seconds, and as the development method, known methods such as an impregnation method, dipping method and shower developing method can be adopted. When an organic solvent is used as the developer, it is air-dried without any other treatments, and when an alkali aqueous solution is used, washing with flowing water is carried out, for example, for 30 to 90 seconds and air drying with compressed air, compressed nitrogen and the like is performed to remove moisture on the surface, thus, a coat in the form of pattern is formed.

For dissociation of a blocking agent, a heating treatment or irradiation with infrared ray can be carried out. Though heating conditions vary depending on the composition, the kind of an additive, and the like, recommendable heating conditions include a temperature of usually 30 to 400° C., preferably 50 to 300° C., and a duration of 5 minutes to 72 hours.

In the present invention, use of a curable dry film for forming optical waveguide of the present invention particularly in a core part can form a fine core form and can prevent lowering of transmission loss.

The present invention will be illustrated specifically by the following examples, but the present invention is not limited to these examples. In the following descriptions, parts and % are parts by weight and % by weight, respectively.

Blocked Acid Group-Containing Copolymer (A):

54 parts of vinyl isopropyl ether, 72 parts of acrylic acid and 100 parts of methyl ethyl ketone were reacted at 60° C. for 2 hours to obtain a reaction product. Then, 45 parts of the resulting reaction product, 45 parts of methyl methacrylate, 10 parts of 2-hydroxyethyl methacrylate and 1 part of azobisbutyronitrile were reacted at 80° C. in a toluene solvent for 8 hours to produce a blocked acid group-containing copolymer (A).

Blocked Acid Group-Containing Copolymer (B):

54 parts of vinyl isopropyl ether, 332 parts of mono(2-hydroxyethyl acrylate)acid phosphate and 100 parts of methyl ethyl ketone were reacted at 60° C. for 2 hours to obtain a reaction product. Then, 45 parts of the resulting reaction product, 45 parts of methyl methacrylate, 10 parts of 2-hydroxyethyl methacrylate and 1 part of azobisbutyronitrile were reacted at 80° C. in a toluene solvent for 8 hours to produce a blocked acid group-containing copolymer (B).

Blocked Acid Group-Containing Copolymer (C):

54 parts of vinyl isopropyl ether, 168 parts of sulfoacrylate and 100 parts of methyl ethyl ketone were reacted at 60° C. for 2 hours to obtain a reaction product. Then, 45 parts of the resulting reaction product, 45 parts of methyl methacrylate, 10 parts of 2-hydroxyethyl methacrylate and 1 part of azobisbutyronitrile were reacted at 80° C. in a toluene solvent for 8 hours to produce a blocked acid group-containing copolymer (C).

Copolymer (D):

10 parts of acrylic acid, 80 parts of methyl methacrylate and 10 parts of 2-hydroxyethyl methacrylate and 1 part of azobisbutyronitrile were reacted at 80° C. in a toluene solvent for 8 hours to produce a copolymer (D).

Curable Resin Composition 1 for Optical Waveguide:

50 parts of the blocked acid group-containing copolymer (A), 50 parts of methyl methacrylate, 1 part of photo-polymerization initiator (trade name: Irgacure 907, manufactured by Chiba Specialty Chemicals) and toluene were compounded to obtain a solution having a solid content of 50% containing the curable resin composition 1.

Curable Dry Film 1D for Optical Waveguide:

A solution containing the above-mentioned curable resin composition 1 for optical waveguide was applied on a polyethylene terephthalate film (thickness: 25 μm) by a knife edge coater, and dried at 80° C. for 30 minutes to produce a dry film 1D.

Curable Resin Composition 2 for Optical Waveguide:

50 parts of the blocked acid group-containing copolymer (B), 50 parts of methyl methacrylate, 1 part of photo-polymerization initiator (Irgacure 907) and toluene were compounded to obtain a solution having a solid content of 50% containing the curable resin composition 2.

Curable Dry Film 2D for Optical Waveguide:

A solution containing the above-mentioned curable resin composition 2 for optical waveguide was applied on a polyethylene terephthalate film (thickness: 25 μm) by a knife edge coater, and dried at 80° C. for 30 minutes to produce a dry film 2D.

Curable Resin Composition 3 for Optical Waveguide:

50 parts of the blocked acid group-containing copolymer (C), 50 parts of methyl methacrylate, 1 part of photo-polymerization initiator (Irgacure 907) and toluene were compounded to obtain a solution having a solid content of 50% containing the curable resin composition 3.

Curable Dry Film 3D for Optical Waveguide:

A solution containing the above-mentioned curable resin composition 3 for optical waveguide was applied on a polyethylene terephthalate film (thickness: 25 μm) by a knife edge coater, and dried at 80° C. for 30 minutes to produce a dry film 3D.

Curable Resin Composition 4 for Optical Waveguide:

50 parts of the blocked acid group-containing copolymer (A), 50 parts of methyl methacrylate, 1 part of photo-polymerization initiator (Irgacure 907), 10 parts of bisphenol A type epoxy resin (epoxy equivalent 475 g/eq, trade name: EPOTOTO YD-011, manufactured by Toto Kasei K.K.) and toluene were compounded to obtain a solution having a solid content of 50% containing the curable resin composition 4. This solution manifested utterly no thickening even in storage at 30° C. for 1 week, showing excellent storage stability.

Curable Dry Film 4D for Optical Waveguide:

A solution containing the above-mentioned curable resin composition 4 for optical waveguide was applied on a polyethylene terephthalate film (thickness: 25 μm) by a knife edge coater, and dried at 80° C. for 30 minutes to produce a dry film 4D.

Curable Resin Composition 5 for Optical Waveguide:

50 parts of the copolymer (D), 50 parts of methyl methacrylate, 1 part of photo-polymerization initiator (Irgacure 907) and toluene were compounded to obtain a solution having a solid content of 50% containing the curable resin composition 5.

Curable Dry Film 5D for Optical Waveguide:

A solution containing the above-mentioned curable resin composition 5 for optical waveguide was applied on a polyethylene terephthalate film (thickness: 25 μm) by a knife edge coater, and dried at 80° C. for 30 minutes to produce a dry film 5D.

Curable Resin Composition 6 for Optical Waveguide:

50 parts of the copolymer (D), 50 parts of methyl methacrylate, 1 part of photo-polymerization initiator (Irgacure 907), 10 parts of bisphenol A type epoxy resin (EPOTOTO YD-011) and toluene were compounded to obtain a solution having a solid content of 50% containing the curable resin composition 6. This solution manifested thickening and gelling in 2 hours at 20° C., showing poor storage stability.

### EXAMPLE 1

A solution containing the above-mentioned curable resin composition 1 for optical waveguide was applied on a plastic base material by a spin coat method, and dried at 80° C. for 30 minutes. Next, the dried composition was irradiated with ultraviolet ray having a wavelength of 365 nm and an illuminance of 10 mW/cm² for 100 seconds via a photomask having a line pattern of 30 μm width, causing ultraviolet ray curing. Then, the base plate having the resin composition layer irradiated with ultraviolet ray was immersed in a developer composed of 1.8% tetramethyl ammonium hydroxide aqueous solution (TMAH aqueous solution) to dissolve un-exposed parts of the resin composition, then, dried. Thus, a core part having a line pattern of 30 μm width was formed. As a result, a fine core form could be formed, and the outline of a dent part on a convex part of the core part was clear. Further, the product showing such clear outline of a dent part did not lower transmission loss of an optical waveguide by deformation of the core part by an upper clad layer or by entrainment of foams and the like into a dent.

### EXAMPLES 2 TO 4

Core parts were formed in the same manner as in Example 1 except that the solutions containing the above-mentioned curable resin compositions 2 to 4 for optical waveguide were used. As a result, a fine core form could be formed, and the outline of a dent part on a convex part of the core part was clear. Further, the product showing such clear outline of a dent part did not lower transmission loss of an optical waveguide by deformation of the core part by an upper clad layer or by entrainment of foams and the like into a dent.

### EXAMPLE 5

The above-mentioned curable dry film 1D for optical waveguide was transferred onto the surface of a plastic base material by a normal pressure heat roll pressure bonding method (temperature: 100° C.), and a polyethylene terephthalate film was peeled. Next, the dried composition was irradiated with ultraviolet ray having a wavelength of 365 nm and an illuminance of 10 mW/cm² for 100 seconds via a photomask having a line pattern of 30 μm width, causing ultraviolet ray curing. Then, this was immersed in a developer composed of 1.8% TMAH aqueous solution to dissolve un-exposed parts of the dry film, then, dried. Thus, a core part having a line pattern of 30 μm width was formed. As a result, a fine core form could be formed, and the outline of a dent part on a convex part of the core part was clear. Further, the product showing such clear outline of a dent part did not lower transmission loss of an optical waveguide by deformation of the core part by an upper clad layer or by entrainment of foams and the like into a dent.

### EXAMPLES 6 TO 8

Core parts were formed in the same manner as in Example 5 except that the above-mentioned curable dry films 2D to 4D for optical waveguide were used. As a result, a fine core form could be formed, and the outline of a dent part on a convex part of the core part was clear. Further, the product showing such clear outline of a dent part did not lower transmission loss of an optical waveguide by deformation of the core part by an upper clad layer or by entrainment of foams and the like into a dent.

### COMPARATIVE EXAMPLE 1

A core part was formed in the same manner as in Example 1 except that the solution containing the above-mentioned curable resin composition 5 for optical waveguide was used. As a result, and the outline of a dent part on a convex part of the core part was unclear. Further, the product showing such unclear outline of a dent part lowered transmission loss of an optical waveguide by deformation of the core part by an upper clad layer or by entrainment of foams and the like into a dent.

1. A curable resin composition for optical waveguide comprising, as essential components,
a copolymer (A) of a radical-polymerizable compound (a) having an acid anhydrous group and/or an acidic group carrying a blocked acid group, and a radical-polymerizable unsaturated group in the molecule, with other radical-polymerizable compound (b),
a polymerizable unsaturated compound (B), and
a polymerization initiator (C).

2. The curable resin composition for optical waveguide according to claim 1, wherein the acid group to be blocked is at least one group selected from carboxyl group, phosphoric acid group, sulfonic acid group and phenolic hydroxyl group.

3. The curable resin composition for optical waveguide according to claim 1, wherein the blocking agent for blocking an acid group contains an ether-bonded olefinic unsaturated group.

4. A curable dry film for optical waveguide comprising, as essential components,
a copolymer (A) of a radical-polymerizable compound (a) having an acid anhydrous group and/or an acidic group carrying a blocked acid group, and a radical-polymerizable unsaturated group in the molecule, with other radical-polymerizable compound (b), the copolymer having a softening temperature of 0 to 300° C.,
a polymerizable unsaturated compound (B), and
a polymerization initiator (C).

5. The curable dry film for optical waveguide according to claim 4, wherein the acid group to be blocked is at least one group selected from carboxyl group, phosphoric acid group, sulfonic acid group and phenolic hydroxyl group.

6. The curable dry film for optical waveguide according to claim 4, wherein the blocking agent for blocking an acid group contains an ether-bonded olefinic unsaturated group.

7. An optical waveguide comprising a lower clad layer, a core part and an upper clad layer wherein at least one of the lower clad layer, the core part and the upper clad layer is formed of a cured substance of a curable dry film for optical waveguide comprising, as essential components,
a copolymer (A) of a radical-polymerizable compound (a) having an acid anhydrous group and/or an acidic group carrying a blocked acid group, and a radical-polymerizable unsaturated group in the molecule, with other radical-polymerizable compound (b), the copolymer having a softening temperature of 0 to 300° C.,
a polymerizable unsaturated compound (B), and
a polymerization initiator (C).

8. The optical waveguide according to claim 7, wherein the difference in specific refractive index between the clad layer and the core part is identical or 0.1% or more.

9. A method for forming a core part for optical waveguide, comprising the following steps:
(1) a step of coating or pasting the curable resin composition for optical waveguide according to claim 1 on a base material for optical waveguide, to provide a resin layer for optical waveguide to be a core part of an optical waveguide,
(2) a step of irradiating light to cure a part to be a core part,
(3) a step of dissociating a blocking agent in an un-cured layer to generate an acidic group, and
(4) a step of removing the un-cured layer by a development treatment to form a core part, wherein step (3) may, optionally, be carried out simultaneously.

10. A method for forming a core part for optical waveguide, comprising the following steps:
(1) a step of coating or pasting the curable dry film for optical waveguide according to claim 4 on a base material for optical waveguide, to provide a resin layer for optical waveguide to be a core part of an optical waveguide,
(2) a step of irradiating light to cure a part to be a core part,
(3) a step of dissociating a blocking agent in an un-cured layer to generate an acidic group, and
(4) a step of removing the un-cured layer by a development treatment to form a core part, wherein step (3) may, optionally, be carried out simultaneously.
